(19) United States
(12) Patent Application Publication
(10) Pub. No.: US 2025/0007598 A1
(43) Pub. Date: Jan. 2, 2025

(54) METHOD, DEVICE AND COMPUTER READABLE MEDIUM FOR COMMUNICATIONS

(71) Applicant: NEC CORPORATION, Tokyo (JP)

(72) Inventors: Peng GUAN, Beijing (CN); Gang WANG, Beijing (CN); Yukai GAO, Beijing (CN)

(73) Assignee: NEC CORPORATION, Tokyo (JP)

(21) Appl. No.: 18/695,681

(22) PCT Filed: Sep. 27, 2021
(86) PCT No.: PCT/CN2021/121094

§ 371 Date: Mar. 26, 2024

(51) Int. Cl. H04B 7/06; H04L 5/00; H04W 72/23

(52) U.S. Cl. CPC H04B 7/06968; H04L 5/0048; H04W 72/23

(57) ABSTRACT

Embodiments of the present disclosure relate to methods, devices and computer readable media for communications. A method implemented at a terminal device comprises in response to switching to a second frequency part, determining a time duration for the terminal device to use a first reference signal received from a network device in a first frequency part as a Quasi Co-location (QCL) reference signal. The terminal device performs communication with the network device before the time duration ends based on a first set of properties obtained by measuring at least the first reference signal. The method also comprises obtaining, within the time duration, a second set of properties by measuring at least a second reference signal received from the network device in the second frequency part, the second reference signal and the first reference signal having a first identification. The method also comprises performing, after the time duration, communication in the second frequency part with the network device based on the second set of properties by using the second reference signal as the QCL reference signal.

### TECHNICAL FIELD

Embodiments of the present disclosure generally relate to the field of telecommunication, and in particular, to methods, devices and computer readable media for communications.

### BACKGROUND

Cross component carrier (CC) beam indication or cross bandwidth part (BWP) beam indication has been supported via a transmission configuration indicator (TCI) state from Release 15. The TCI state contains an information element (IE) of quasi co-location information (QCL-Info) which includes a CC identity (ID) or BWP ID of in a cell field or a bwp-Id field. If the field is absent, it applies to a serving cell in which the TCI State is configured.

In Release 17, to avoid duplicated signaling, a TCI state pool is introduced. When the CC ID or BWP ID for QCL-Type A or D source reference signal (RS) in QCL-Info of the TCI state is absent, a terminal device assumes that QCL-Type A or D source RS is in the BWP or CC to which the TCI state applies.

In addition, BWP switching or CC switching is supported. Right after BWP switching or CC switching, the terminal device could not obtain large scale properties from the indicated TCI state if QCL-Type A or D source RS is in the BWP or CC to which the TCI state applies when no BWP ID or CC ID is configured for the RS.

### SUMMARY

In general, example embodiments of the present disclosure provide methods, devices and computer readable media for communications.

In a first aspect, there is provided a method for communications implemented at a terminal device. The method comprises in response to switching to a second frequency part, determining a time duration for the terminal device to use a first reference signal received from a network device in a first frequency part as a Quasi Co-location (QCL) reference signal. The terminal device performs communication with the network device before the time duration ends based on a first set of properties obtained by measuring the first reference signal. The method also comprises obtaining, within the time duration, a second set of properties by measuring a second reference signal received from the network device in the second frequency part. Both the second reference signal and the first reference signal have a first identification. The method also comprises performing, after the time duration, communication in the second frequency part with the network device based on the second set of properties by using the second reference signal as the QCL reference signal.

In a second aspect, there is provided a method for communications implemented at a network device. The method comprises in response to switching to a second frequency part, determining a time duration for a terminal device to use a first reference signal transmitted by the network device in a first frequency part as a QCL reference signal, the terminal device performing communication with the network device before the time duration ends based on a first set of properties obtained by measuring the first reference signal. The method also comprises transmitting, to the terminal device, a second reference signal in the second frequency part after a start of the time duration. Both the second reference signal and the first reference signal have a first identification. The method also comprises performing, after the time duration, communication in the second frequency part with the terminal devices by using the second reference signal as the QCL reference signal.

In a third aspect, there is provided a terminal device. The terminal device comprises a processor and a memory storing instructions. The memory and the instructions are configured, with the processor, to cause the terminal device to perform the method according to the first aspect.

In a fourth aspect, there is provided a network device. The network device comprises a processor and a memory storing instructions. The memory and the instructions are configured, with the processor, to cause the network device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented:

FIG. 2 illustrates an example of BWP switching or CC switching in the prior art:

FIG. 3 illustrates an example signaling chart showing an example process for frequency part switching in accordance with some embodiments of the present disclosure:

FIGS. 4A, 4B and 4C illustrate an example format of Media Access Control Control Element (MAC CE) activation command in accordance with some embodiments of the present disclosure, respectively:

FIG. 5 illustrates an example of BWP switching or CC switching in accordance with some embodiments of the present disclosure:

FIG. 6A illustrates an example of BWP switching or CC switching in accordance with some other embodiments of the present disclosure:

FIG. 6B illustrates an example of BWP switching or CC switching in accordance with some other embodiments of the present disclosure:

FIG. 7 illustrates an example of BWP switching or CC switching in accordance with still other embodiments of the present disclosure:

FIG. 8 illustrates an example of BWP switching or CC switching in accordance with still other embodiments of the present disclosure:

FIG. 9 illustrates a flowchart of an example method in accordance with some embodiments of the present disclosure:

FIG. 10 illustrates a flowchart of an example method in accordance with some other embodiments of the present disclosure: and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has “multicast/broadcast” feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHZ-7125 MHZ), FR2 (24.25 GHz to 71 GHZ), frequency band larger than 100 GHz as well as Tera Hertz(THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments and an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below:

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the following, the terms “PUSCH transmission”, “PUSCH transmission occasion”, “uplink transmission”, “PUSCH repetition”, “PUSCH occasion” and “PUSCH reception” can be used interchangeably. The terms “transmission”, “transmission occasion” and “repetition” can be used interchangeably. The terms “precoder”, “precoding”, “precoding matrix”, “beam”, “spatial relation information”, “spatial relation info”, “TPMI”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter” and “spatial relation” can be used interchangeably: The terms “SRI”, “SRS resource set index”, “UL TCI”, “UL spatial domain filter”, “UL beam”, “joint TCI” can be used interchangeably. The terms “QCL reference”, “QCL source”, “QCL reference RS”, “QCL source RS”, “QCL RS” can be used interchangeably. The terms “BWP/CC”, “BWP”, “CC”, “carrier”, “SCell”, “cell”, “serving cell”, “cell group”, and “physical cell” can be used interchangeably. The terms “release 17”,“r17”, and “Rel 17” can be used interchangeably.

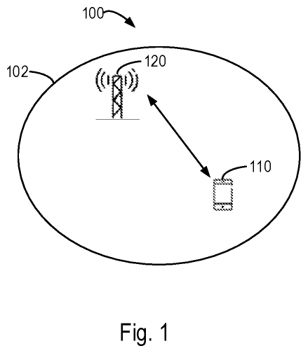

FIG. 1 shows an example communication network 100 in which embodiments of the present disclosure can be implemented. The network 100 includes a terminal device 110 and a network device 120 that serves the terminal device 110. A serving area of the network device 120 is called as a cell 102. It is to be understood that the number of network devices and terminal devices is only for the purpose of illustration without suggesting any limitations.

The system 100 may include any suitable number of network devices and terminal devices adapted for implementing embodiments of the present disclosure. Although not shown, it would be appreciated that one or more terminal devices may be located in the cell 102 and served by the network device 120.

Communications in the communication network 100 may be implemented according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As mentioned above, cross CC beam indication or cross BWP beam indication has been supported via a TCI state from Release 15. The TCI state contains a QCL-Info IE which includes a CC ID or BWP ID of in a cell field or a bwp-Id field. For example, the TCI-State IE may comprise the following information:

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

...
}

| QCL-Info ::= | SEQUENCE { | |
|---|---|---|
| cell | ServCellIndex | OPTIONAL, -- Need R |
| bwp-Id | BWP-Id | OPTIONAL, -- Cond CSI- |

RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

Table 1 shows descriptions of QCL-Info field.

TABLE 1
QCL-Info field descriptions

```
bwp-Id
The DL BWP which the RS is located in.
cell
The UE's serving cell in which the referenceSignal
is configured. If the field is absent, it
applies to the serving cell in which the TCI-State
is configured. The RS can be located
on a serving cell other than the serving cell in
which the TCI-State is configured only if the
qcl-Type is configured as typeC or typeD.
referenceSignal
Reference signal with which quasi-collocation information is provided.
qcl-Type
QCL type as specified
  ‘typeA’: {Doppler shift, Doppler spread, average delay, delay spread}
  ‘typeB’: {Doppler shift, Doppler spread}
  ‘typeC’: {Doppler shift, average delay}
  ‘typeD’: {Spatial Rx parameter}
```

We may configure RS from other CC as QCL type C or type D source RS by configuring both CC ID and RS ID. QCL type A or type B source RS must be located in the serving cell as the target RS, i.e., cross-CC is not supported. If CC ID is absent, CC ID is the CC ID where this TCI state is configured.

From release 17, a TCI state pool may be configured in the reference BWP or CC, and can be shared by other BWP or CC by a reference link to the reference BWP or CC, which can reduce a lot of signaling redundancy. If BWP ID or CC ID is absent, this BWP ID or CC ID of RS is the BWP ID or CC ID where this TCI state is applied. QCL type A or B source RS must be located in the serving cell as the target RS, i.e., cross-CC is still not supported.

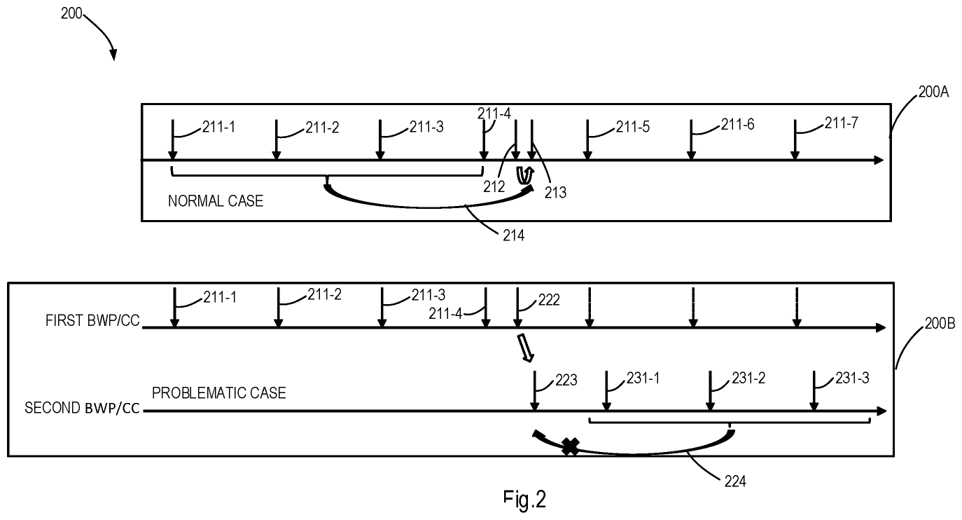

In addition, BWP switching or CC switching is supported. Right after BWP switching or CC switching, the terminal device could not obtain large scale properties from the indicated TCI state if QCL-Type A or D source RS is in the BWP or CC to which the TCI state applies when no BWP ID or CC ID is configured for the RS. BWP switching or CC switching leads to a problem that BWP/CC ID plus RS ID points to an RS in the second BWP or CC, but the terminal device does not have any measurement in the second BWP or CC. Therefore, the terminal device can not use the RS as QCL reference to receive DL transmission. This will described with reference to FIG. 2.

FIG. 2 illustrates an example 200 of BWP switching or CC switching in the prior art. As shown, in a normal case 200A, a terminal device receives RS 211-1, 211-2, 211-3 and 211-4 from a network device in a first BWP or first CC (which is also referred to as first BWP/CC). It should be understood that transmission of RS 211-1 to RS 211-7 may be a multiple transmission of a single RS, for example, a periodic transmission of the single RS. The terminal device receives physical downlink control channel (PDCCH) 212 scheduling physical downlink shared channel (PDSCH) 213 in the first BWP/CC. Based on QCL relationship 214 indicated in TCI state contained in PDCCH 212, the terminal device 110 receives PDSCH 213.

It should be noted that cross-BWP/CC QCL-Type A relationship has not yet been supported, which means tracking RS and PDCCH/PDSCH Demodulation Reference Signal (DMRS) should be in the same BWP/CC. Therefore, one reasonable configuration could be that BWP/CC ID for QCL-Type A source RS is always absent. This kind of configuration indeed has some advantages. For example, it can reduce the required number of configured TCI states, and avoid redundant TCI state activation signalling.

However, one issue can be identified considering BWP/CC switching, especially for dynamic switching. This will be described with reference to a problematic case 200B in FIG. 2.

In the problematic case 200B, the terminal device receives physical downlink control channel (PDCCH) 222 scheduling physical downlink shared channel (PDSCH) 223 in a second BWP or second CC (which is also referred to as second BWP/CC). ID of the second BWP/CC plus RS ID points to RS 231-1, 231-2 and 231-3 in the second BWP/CC. It should be understood that transmission of RS 231-1 to RS 231-3 may be a multiple transmission of a single RS, for example, a periodic transmission of the single RS. Right after BWP switching or CC switching, the terminal device does not have any measurement in the second BWP or CC, thus the terminal device could not obtain large scale properties of the RS 231-1, 231-2 and 231-3. Therefore, the terminal device can not use the RS 231-1, 231-2 and 231-3 as QCL reference to receive PDSCH 223. In other words, the terminal device may not be able to obtain measurement results from QCL-Type A source RS right after BWP/CC switching, when BWP/CC ID is absent for the QCL-Type A source RS in a QCL-Info of the TCI state.

It should be understood that dashed arrows in FIG. 2 represents no actual transmission or measurement.

Embodiments of the present disclosure provide a solution for frequency part switching so as to solve the above problems and one or more of other potential problems. According to the solution, in response to switching to a second frequency part, a terminal device determines a time duration for the terminal device to use a first RS received from a network device in a first frequency part as a QCL source RS. Before the time duration ends, the terminal device performs communication with the network device based on a first set of properties obtained by measuring at least the first RS. The terminal device obtains, within the time duration, a second set of properties by measuring at least a second RS received from the network device in the second frequency part. Both the second RS and the first RS have a first identification. The terminal device performs, after the time duration, communication in the second frequency part with the network device based on the second set of properties by using the second RS as the QCL source RS. In this way, the terminal device is given enough time to measure new RS identified by an identity of the second frequency part and an identity of the RS.

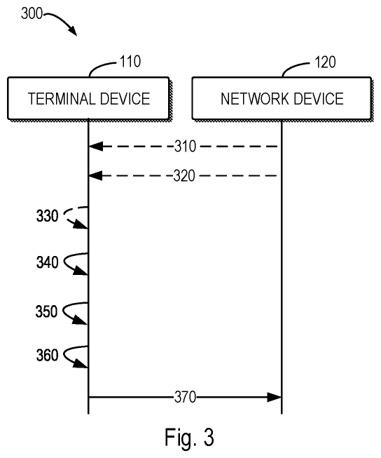

Principle of the present disclosure will now be described with reference to FIGS. 3 to 10. Reference is now made to FIG. 3, which shows a signaling chart illustrating a process 300 for frequency part switching according to some example embodiments of the present disclosure. For the purpose of discussion, the process 300 will be described with reference to FIG. 1. The process 300 may involve the terminal device 110 and the network device 120 as illustrated in FIG. 1. Although the process 300 has been described in the communication network 100 of FIG. 1, this process may be likewise applied to other communication scenarios.

As shown in FIG. 3, the terminal device 110 switches (340) to a second frequency part.

In some embodiments, the terminal device 110 may switch from a first frequency part to the second frequency part. In some embodiments, the terminal device 110 may switch from a frequency part other than the first and the second frequency part to the second frequency part. In some embodiments, each of the first and second frequency parts may be a BWP or a CC. In some embodiments, each of the first and second frequency parts may be a carrier, a cell, a physical cell, a cell group, a band, or a band combination.

In some embodiments, the first frequency part may be one of the following: an active BWP before the BWP switching, an active CC before the CC switching, a BWP or CC in which the scheduling information is transmitted, a BWP or CC in which TCI-State is configured, a BWP or CC in which Release 17 TCI-State is configured, a BWP or CC in which one or more TCI state pools are configured, a reference BWP or a reference CC, a default BWP or a default CC, an initial downlink or uplink BWP, or an initial downlink or uplink CC.

In embodiments wherein each of the first and second frequency parts is a BWP or a CC, the switching from one frequency part to another frequency part is also referred to as BWP/CC switching. For the purpose of discussion, embodiments of the present disclosure will be described by taking BWP/CC as an example of the first and second frequency parts. Of course, switching of other frequency part than BWP/CC switching may be applied to the present disclosure.

In some embodiments, the BWP switching may be based on a timer. The timer may be a bwp-Inactivity Timer. In some other embodiments, the BWP switching may be based on a dynamic indication. For example, the BWP switching may be based on a bandwidth part indicator in DCI.

The terminal device 110 is not required to transmit uplink (UL) signals or receive downlink (DL) signals during the switch delay:

In some embodiments, the CC switching may be based on a timer. The timer may be a sCellDeactivationTimer. In some embodiments, the CC switching may be based on configuration or reconfiguration via radio resource control (RRC) signaling. In addition, the CC switching may be dynamically activating or deactivating CCs via MAC CE. Furthermore, the CC switching may be cross carrier scheduling among activated CCs via a carrier indicator in DCI.

In some embodiments, a configured time interval for the switching may be configured and may be represented by T_{switch}. The configured time interval may comprise a switching delay for the BWP switching, which may be represented by T_{BWPswitchdelay}. The configured time interval may comprise a switching delay for the CC switching, which may be represented by T_{CCswitchdelay}. The configured time interval may comprise a switching delay for a carrier switching, a cell switching, a physical cell switching, a cell group switching, a band switching, or a band combination switching. The terminal device 110 is not required to transmit UL signals or receive DL signals during n+T_{switch}, where n represents a starting slot when the terminal device 110 is aware of the switching. For example, the terminal device 110 is aware of the switching by receiving, decoding or acknowledging the BWP/CC switching command.

In some embodiments, optionally, before the switching, the terminal device 110 may receive (310) configuration information from the network device 120.

In some embodiments, the configuration information may comprise TCI state pool configuration. In some embodiments, the configuration information may be per CC configuration, and also may be configured per band combination, per band or CC group, or per CC or BWP.

In some embodiments, the configuration information may comprise at least one of: a starting slot when the terminal device 110 is aware of the switching, a configured time interval for the switching, a periodicity of the second RS, a configured number of transmission occasions of the second RS, a QCL type of the second RS, numerology information the second RS, or a predefined capability-related value of the terminal device 110.

In embodiments where the configuration information comprises TCI state pool configuration, the TCI state pool configuration may comprise following information:
TCI state pool (optional)
   tciStatePoolId (optional)
   List of TCI-State-r17
      list of {cell (optional)+bwp-Id (optional)+tci-State_r17}
TCI-State-r17
   tci-StateId r17
   tci-State Type (optional)
   qcl-Type1: QCL-Info-r17
   qcl-Type2: QCL-Info-r17 (if configured)
QCL-Info-r17
   cell (optional)
   bwp-Id (optional)

```
referenceSignal choice of
  NZP-CSI-RS-ResourceId (CSI-RS for beam management or CSI-
  RS for tracking, used for DL/UL TCI or Joint TCI state);
  SSB-Index;
  SRS ResourceId (SRS for beam management, used for UL TCI);
  }
  qcl-Type ENUMERATED {typeA, typeB, typeB, typeD}
  pathloss RS (optional) choice of {
    SSB-Index;
    NZP-CSI-RS-ResourceId (periodic CSI-RS);
    }
```

TCI-State-r17 can be referred as release 17 TCI state. QCL-Info-r17 can be reference as release 17 QCL-Info. Table 2 shows descriptions of TCI-State-r17 and QCL-Info-r17 fields.

TABLE 2
TCI-State-r17 and QCL-Info-r17 fields descriptions

tci-StateType
Type of TCI state: DL only, or UL only, or Joint
(optional, DL only + UL only)
qcl-Type
qcl-Type1 and qcl-Type2 should not have the same qcl-Type, for example
qcl-Type1: QCL-Info-r17 for QCL Type A or B, C for DL
qcl-Type2: QCL-Info-r17 for QCL Type D
for DL or UL Tx spatial filter for UL

It should be noted that BWP/CC ID of TCI states in the TCI state pool is different from BWP/CC ID of RS. If BWP/CC ID of TCI states in the TCI state pool is absent, the configured BWP/CC ID is assumed, or the scheduling/scheduled/applied BWP/CC ID is assumed.

It should also be noted that one most reasonable example about BWP/CC ID of RS is following: BWP/CC ID is not configured for QCL TYPE A/B/C source RS, tracking RS should be located per BWP/CC and the number of required TCI states is reduced significantly: BWP/CC ID is configured for QCL TYPE D source RS, and points to a BWP/CC for beam management, thus same receiving (transmitting if UL) beam is applied across BWP/CC.

It should also be noted that for other CC/BWP without dedicated TCI state pool configuration, the BWP/CC ID may be linked to the one configured with TCI state pool.

In some embodiments, optionally, before the switching, the terminal device 110 may receive (320) DCI or a MAC CE activation command from the network device 120. The DCI or a MAC CE activation command comprises a TCI state indication. A TCI state identification (ID) in the TCI state indication points to a TCI state in a TCI state pool.

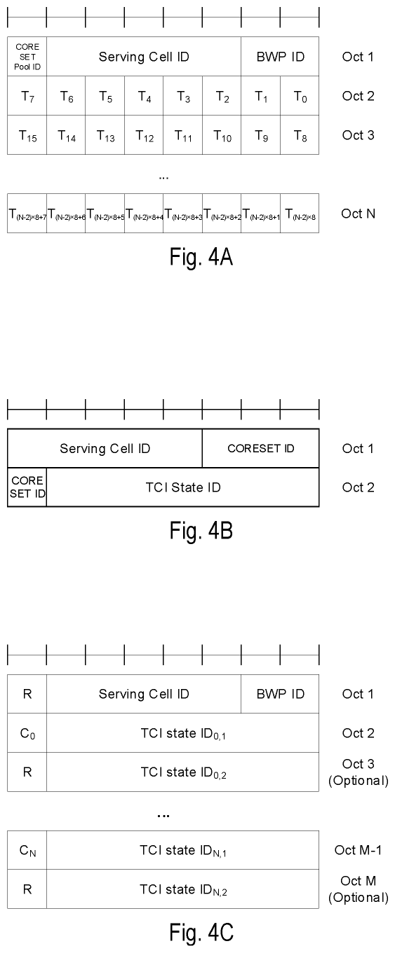

In some embodiments, the legacy format of the MAC CE activation command as shown in FIG. 4A, FIG. 4B and FIG. 4C may be reused with the following modifications. For example, if reference BWP/CC is known (e.g., via RRC configuration) and there is only one TCI state pool configured in the reference BWP/CC, then the terminal device 110 may use indicated (Serving cell ID+BWP ID) in the legacy MAC CE command to find the reference BWP/CC, via the configured link between BWP/CCs. In some embodiments, the MAC CE activation command can activate TCI states in all linked BWP/CCs. In some embodiments, the MAC CE activation command can activate TCI states in all linked active BWP/CCs. In addition, in FIG. 4A, the Ti could be the order (i-th or (i+1)-th) of the TCI state in configured

TCI state list, via TCI state pool configuration, in FIG. 4B and 4C TCI state ID points to TCI states in TCI state pool instead of pointing to TCI states configured in the BWP/CC with indicated (Serving cell ID+BWP ID).

In addition, TCI states can be grouped in multiple subsets. TCI states in each subset are associated with a different physical cell ID (PCI). For example, TCI states associated with a serving cell can be grouped in a first subset, TCI states associated with a non serving cell (i.e., with a different PCI other than the serving cell) can be grouped in a second subset. In some embodiments, TCI state activation is based on the order of TCI state(s) in first subset, and then TCI state(s) in the second subset. In other embodiments, TCI state activation is based on the order of TCI state(s) which associated with PCI of the serving cell, and then TCI state(s) which associated with a different PCI.

Optionally, MAC CE activation command as shown in FIG. 4A can be used to activate TCI states applies to at least the terminal device dedicated channels/RSs and MAC CE activation command as shown in FIG. 4B can be used to activate TCI states applies to non-dedicated channels/RSs, e.g., common PDCCH. In some embodiments, if MAC CE activation command as shown in FIG. 4B is used to indicate TCI state for PDCCH, the corresponding PDCCH contain TCI field point to release 15/16 TCI state only for the scheduled PDSCH. In some embodiments, if MAC CE activation command as shown in FIG. 4A is used to indicate TCI state for PDCCH (i.e., release 17 common TCI), the corresponding PDCCH contain TCI field point to release 17 TCI state for all channels/RSs that the indicated TCI state apply to, which at least includes one of terminal device dedicated PDCCH/PDSCH, terminal device dedicated PUCCH/PUSCH.

In other embodiments, a new format of the DCI or MAC CE activation command for PDCCH may include at least one of {TCI state pool ID, BWP/CC ID, TCI state ID}. In some embodiments, the DCI or MAC CE activation command can activate TCI states in the indicated BWP/CCs. In some embodiments, if reference BWP/CC is known (e.g., via RRC configuration) and there is only one TCI state pool configured in the reference BWP/CC, then the terminal device 110 may use indicated (Serving cell ID+BWP ID) in the DCI or MAC CE command to find the reference BWP/CC, via the configured link between BWP/CCs. In some embodiments, the DCI or MAC CE activation command can activate TCI states in all linked BWP/CCs. In some embodiments, the DCI or MAC CE activation command can activate TCI states in all linked active BWP/CCs.

With continued reference to FIG. 3, in some embodiments, optionally, before the switching, the terminal device 110 may obtain (330) the first set of properties by measuring at least the first RS. The terminal device 110 may record the obtained first set of properties.

In some embodiments, the first RS may be identified by an ID of the first frequency part and RS ID. For example, the first RS may be identified by first BWP/CC ID+RS ID.

In some embodiments, the RS ID may be the ID of RS in QCL-Info of a TCI state for at least one of the following:
Only for Type A/B/C RS,
Also for Type D RS,
Also for Pathloss RS.

In some embodiments, the first BWP/CC ID may be the ID for one of the following
the active BWP/CC before BWP/CC switch
the BWP/CC in which the scheduling information is transmitted
the BWP/CC in which the TCI-State is configured
the BWP/CC in which the release 17 TCI-State is configured
the BWP/CC in which TCI state pool(s) are configured
a reference BWP/CC
a default BWP/CC, e.g., BWP/CC with a certain ID, like lowest/highest ID
the initial DL/UL BWP/CC

Returning to FIG. 3, in response to the switching, the terminal device 110 determines (350) a time duration for the terminal device 110 to use a first RS received from the network device 120 in the first frequency part as a QCL RS. Before the time duration ends, the terminal device 110 performs communication with the network device 120 based on a first set of properties obtained by measuring the first RS.

In some embodiments, the terminal device 110 may determine, based on the configuration information received from the network device 120, the starting slot (represented by n, as discussed above) when the terminal is aware of the switching. The terminal device 110 may also determine, based on the configuration information, the configured time interval for the switching (represented by T_{switch}, as discussed above). The terminal device 110 may determine a QCL time interval for obtain the second set of properties. Hereinafter, the QCL time interval for obtain the second set of properties may be represented by T_{QCL}. In turn, the terminal device 110 may determine the time duration based on at least one of the following: the starting slot, the configured time interval for the switching and the QCL time interval.

In some embodiments, the QCL time interval T_{QCL} may be related to the periodicity of the second RS. For example, the QCL time interval T_{QCL} may be N times of the periodicity of the second RS. Also, the time duration ends means after the N-th transmission occasions or N-th measurement occasions of the second RS after BWP/CC switching. In some embodiments, N may be determined based on the configuration information from the network device 120, a capability of the terminal device 110, or a standard requirement.

In some embodiments, the QCL time interval T_{QCL} may be related to QCL type of the second RS. For example, the QCL time interval T_{QCL} may be N1 for type A, N2 for type B, N3 for type C, N4 for type D, and N5 for pathloss RS.

In some embodiments, the QCL time interval T_{QCL} may be related to numerologies like subcarrier spacing (SCS).

In some embodiments, the QCL time interval T_{QCL} may be a configured value, a predefined value, or a value related to capability of the terminal device 110.

Upon determination of the time duration, the terminal device 110 obtains (360), within the time duration, a second set of properties by measuring at least a second RS received from the network device 120 in the second frequency part. The first RS and the second RS have a first identification (ID). Hereinafter, the first ID may be also referred to as the first RS ID. In some embodiment, the first RS and the second RS could have the different identification. In other words, the first RS and the second RS have the different RS ID. In some embodiment, when the first RS and the second RS having the different RS ID, the terminal device 110 obtains (360), within the time duration, a second set of properties by measuring at least the second RS received from the network device 120 in the second frequency part, and in response to switching to a second frequency part, determining a time duration for the terminal device to use the first reference signal received from a network device in a first frequency part as a Quasi Co-location (QCL) reference signal, the terminal device performing communication with the network device before the time duration ends based on a first set of properties obtained by measuring at least the first reference signal: wherein the first reference signal and the second reference signal have the different RS ID.

In some embodiments, the first RS and the second RS may be RS of the same QCL type. For example, the first RS and the second RS may be RS of QCL type A, QCL type B or QCL type C. For the purpose of discussion, QCL type A, QCL type B or QCL type C may be also referred to as QCL type A/B/C.

In some embodiments, the terminal device 110 may obtain the second set of properties by the following. The terminal device 110 may determine a QCL type of the second RS based on configuration information received from the network device 120. In turn, the terminal device 110 may determine the second set of properties based on the QCL type by measuring the second RS in the second frequency part.

In some embodiments, the terminal device 110 may determine the second set of properties based on the QCL type by the following. If the QCL type is QCL type A, the terminal device 110 may determine a Doppler shift, a Doppler spread, an average delay, a delay spread based on a result of the measuring of the second RS. If the QCL type is QCL type B, the terminal device 110 may determine a Doppler shift and a Doppler spread based on a result of the measuring of the second RS. If the QCL type is QCL type C, the terminal device 110 may determine a Doppler shift and an average delay based on a result of the measuring of the second RS. If the QCL type is QCL type D, the terminal device 110 may determine a spatial Rx parameter based on a result of the measuring of the second RS.

Upon obtaining the second set of properties, after the time duration, the terminal device 110 performs (370) communication in the second frequency part with the network device 120 based on the second set of properties by using the second RS as the QCL source

RS.

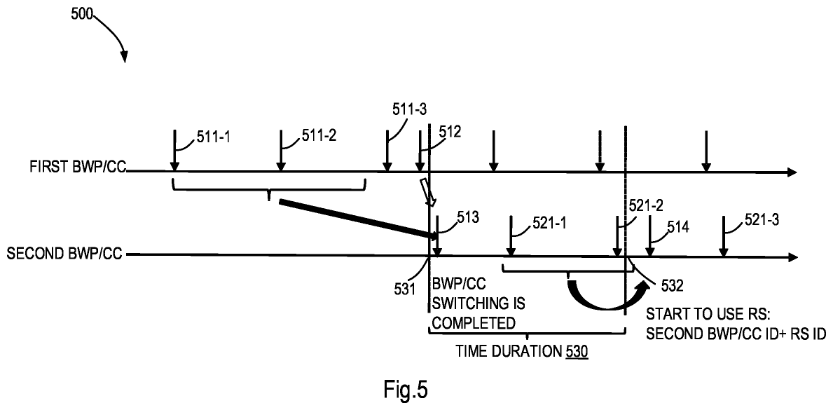

FIG. 5 illustrates an example 500 of BWP switching or CC switching in accordance with some embodiments of the present disclosure. Generally, in the example 500, the terminal device 110 could keep the QCL assumption before the terminal device 110 can obtain new and stable results after several measurements of the QCL-Type A source RS in the new BWP/CC. A time duration can be introduced for the terminal device 110 to measure the RS identified by (second BWP/CC ID+first RS ID). During this time duration, the terminal device 110 is allowed to communicate with the network device 120 based on QCL assumption with RS in the last BWP before BWP switching (i.e., first BWP ID+first RS ID). The length of the time duration may be N (e.g., 3) times the periodicity of the corresponding RS.

Specifically, as shown, the terminal device 110 receives first RS 511-1, 511-2 and 511-3 from the network device 120 in the first BWP/CC. The first RS 511-1, 511-2 and 511-3 may be identified by (a first BWP/CC ID+RS ID). It should be understood that transmission of RS 511-1 to RS 511-3 may be a multiple transmission of a single RS, for example, a periodic transmission of the single RS. The terminal device 110 receives PDCCH 512 scheduling PDSCH 513 in the second BWP/CC. Dashed arrows in FIG. 5 represent no actual transmission.

The network device 120 transmits second RS 521-1, 521-2 and 521-3 in the second BWP/CC. It should be understood that transmission of RS 521-1 to RS 521-3 may be a multiple transmission of a single RS, for example, a periodic transmission of the single RS. The second BWP/CC ID is absent for RS in QCL-Info of a TCI state.

At a start 531 of a time duration 530, the terminal device 110 completes the procedure of switching to the second BWP/CC. After switching to the second BWP/CC, the terminal device 110 uses the first RS identified by (the first BWP/CC ID+RS ID) as QCL RS until the time duration 530 ends at 532.

Within the time duration 530, the terminal device 110 obtains the second set of properties by measuring the second RS 521-1 and 521-2 in the second BWP/CC.

After the time duration 530, the terminal device 110 uses the second RS 521-3 identified by (the second BWP/CC ID+RS ID) as QCL reference RS. In addition, after the time duration 530, the terminal device 110 receives PDSCH 514 in the second BWP/CC based on the second set of properties. In addition, after the time duration, the terminal device receives/transmits all channels/RSs that the indicated TCI state apply to in the second BWP/CC based on the second set of properties, which at least includes one of terminal device dedicated PDCCH/PDSCH, terminal device dedicated PUCCH/PUSCH.

Embodiments of the present disclosure support the terminal device 110 to assume QCL-Type A source RS is in the last BWP/CC before BWP/CC switching until it can obtain new measurement results in the new BWP/CC, if BWP/CC ID is absent for the QCL-Type A source RS. In addition, embodiments of the present disclosure give the terminal device 110 enough time to measure new RS identified by (the second BWP/CC ID+RS ID).

In some embodiments, BWP/CC switching deactivates TCI states in which BWP/CC is switched from. In some other embodiments, BWP/CC switching activates TCI states in which BWP/CC is switched to.

In some embodiments, after switching to the second BWP/CC, the terminal device assumes QCL source RS in a QCL-Info of the old TCI state is in the first BWP/CC until the terminal device receives MAC CE or DCI based TCI state activation or indication. The old TCI state can be the applied TCI state when the terminal device 110 is aware of the switching by receiving, decoding or acknowledging the BWP/CC switching command.

In some embodiments, after switching to the second BWP/CC, the terminal device assumes QCL source RS in a QCL-Info of the old TCI state is in the first BWP/CC before the time duration ends, and the terminal device assumes QCL source RS in a QCL-Info of the old TCI state is in the second BWP/CC after the time duration, until the terminal device receives MAC CE or DCI based TCI state activation or indication. The old TCI state can be the applied TCI state when the terminal device 110 is aware of the switching by receiving, decoding or acknowledging the BWP/CC switching command.

In some embodiments, after switching to the second BWP/CC, the terminal device assumes QCL source RS in a QCL-Info of the indicated TCI state is in the first BWP/CC until the terminal device receives MAC CE or DCI based TCI state activation or indication. The indicated TCI state can be the TCI state received together with, right before, or right after the BWP/CC switching command.

In some embodiments, after switching to the second BWP/CC, the terminal device assumes QCL source RS in a QCL-Info of the indicated TCI state is in the first BWP/CC before the time duration ends, and the terminal device assumes QCL source RS in a QCL-Info of the indicated TCI state is in the second BWP/CC after the time duration, until the terminal device receives MAC CE or DCI based TCI state activation or indication. The indicated TCI state can be the TCI state received together with, right before, or right after the BWP/CC switching command.

In some embodiments, the terminal device 110 may switch back to the first frequency part from the second frequency part due to expiry of a timer. For example, in the case of BWP switching, the timer may be the legacy RRC IE bwp-Inactivity Timer (also referred to as bwp-Inactivity Timer hereinafter). For the bwp-Inactivity Timer, the duration in ms after which the terminal device 110 falls back to the default Bandwidth Part (see TS 38.321, clause 5.15). For example, in the case of CC switching like MAC CE based SCell activation, the timer may be the legacy RRC IE sCellDeactivationTimer.

In some embodiments, considering timer based BWP/CC switching, for example, right after switching back to the first BWP from the second BWP due the expiry of configured bwp-Inactivity Timer, it could be possible that the terminal device 110 could still use the measurement results from RS in BWP #1 if the value of the timer is small, for example, smaller than [1280 ms]. In such embodiments, in response to switching back to the first frequency part, the terminal device 110 may determine a time period of a timer from the last transmission in the first frequency part. For example, the time period of the timer is related to a configured value of bwp-Inactivity Timer.

In some embodiments, the last transmission may be transmission of RS and the RS may be identified by (the first BWP/CC ID+RS ID). Alternatively, the last transmission may be any transmission including data transmission

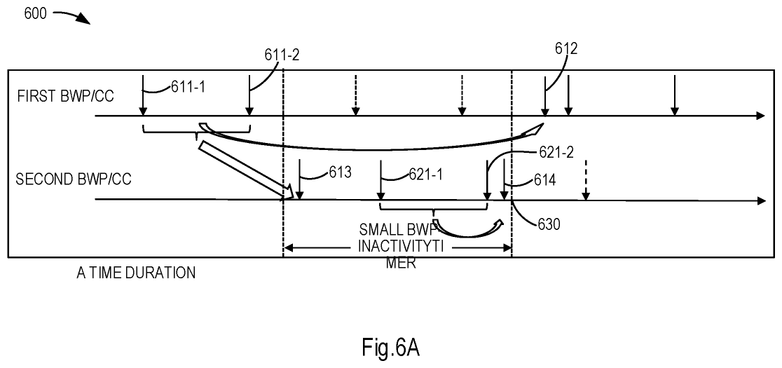

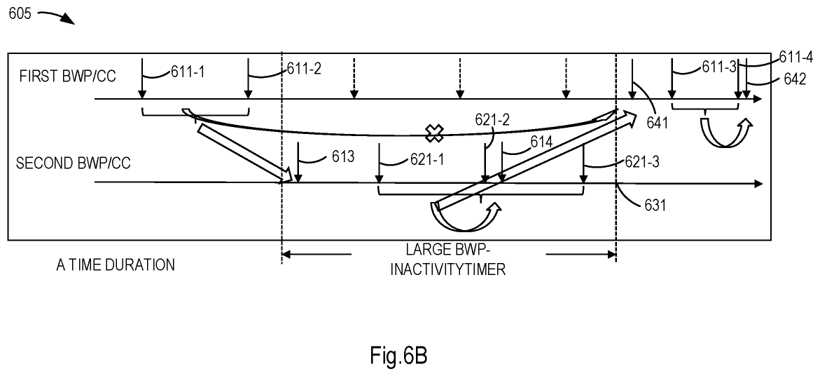

If the time period is smaller than a first threshold, the terminal device 110 may perform communication with the network device 120 in the first frequency part by using the first RS as the QCL source RS. The first threshold may be predefined, configured by the network device 120, or reported as a capability by the terminal device 110. This will be described with reference to FIG. 6A.

FIG. 6A illustrates an example 600 of BWP switching or CC switching in accordance with some embodiments of the present disclosure.

As shown, the terminal device 110 receives first RS 611-1 and 611-2 from the network device 120 in the first BWP/CC. The first RS 611-1 and 611-2 may be identified by (a first BWP/CC ID +RS ID). The terminal device 110 receives PDSCH 613 in the second BWP/CC by using the first RS 611-1 and 611-2 as QCL source RS. Dashed arrows in FIG. 6A represent no actual transmission or measurement.

The network device 120 transmits second RS 621-1 and 621-2 in the second BWP/CC.

After switching to the second BWP/CC and obtaining the second set of properties by measuring the second RS 621-1 and 621-2 in the second BWP/CC, the terminal device 110 receives PDSCH 614 in the second BWP/CC based on the second set of properties.

Due to the bwp-Inactivity Timer expires at 630, the terminal device 110 switches back to the first BWP/CC from the second BWP/CC. Because the time period of the bwp-Inactivity Timer from the last transmission in the first BWP/CC is smaller than the first threshold, the terminal device 110 receives PDSCH 612 in the first BWP/CC by using the first RS 611-1 and 611-2 as the QCL source RS.

With the solution in the example 600, it is faster to achieve a stable transmission if the terminal device 110 could reuse the previous QCL assumption.

On the other hand, if the time period is larger than or equal to the first threshold, the terminal device 110 may perform communication with the network device 120 in the first frequency part by using the second RS as the QCL source RS. The terminal device 110 may obtain a third set of properties by measuring the first RS and perform communication with the network device 120 in the first frequency part based on the third set of properties by using the first RS as the QCL RS. In other words, for timer-based BWP/CC switching, some embodiments of the present disclosure support the terminal device 110 to assume QCL-Type A source RS is in the last BWP/CC before BWP/CC switching only if the value of the timer is larger than a threshold, if BWP/CC ID is absent for the QCL-Type A source RS. This will be described with reference to FIG. 6B.

FIG. 6B illustrates an example 605 of BWP switching or CC switching in accordance with some embodiments of the present disclosure.

The example 605 is mainly different from the example 600 in that the time period of the bwp-Inactivity Timer from the last transmission in the first BWP/CC is larger than or equal to the first threshold.

Due to the bwp-Inactivity Timer expires at 631, the terminal device 110 switches back to the first BWP/CC from the second BWP/CC. After the switching, the terminal device 110 receives PDSCH 641 by using the second RS 621-1, 621-2 and 621-3 as QCL source RS.

In addition, because the time period of the bwp-Inactivity Timer from the last transmission in the first BWP/CC is larger than or equal to the first threshold, after the switching, the terminal device 110 obtains a third set of properties by measuring the first RS 611-3 and 611-4 in the first BWP/CC. Then, the terminal device 110 receives PDSCH 642 in the first BWP/CC by using the first RS 611-3 and 611-4 as QCL RS.

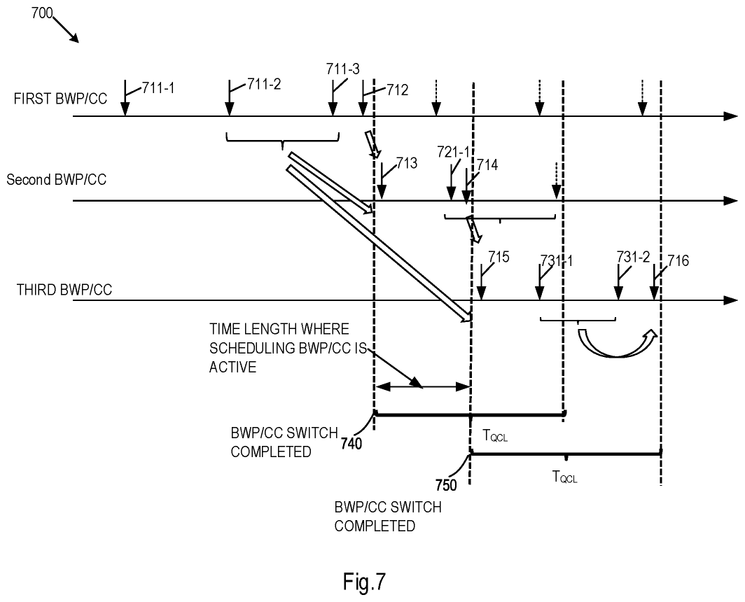

In some embodiments, the terminal device 110 may further switch from the second frequency part to a third frequency part before the second set of properties is obtained. In such embodiments, in response to the further switching, the terminal device 110 may determine a time length during which a scheduling frequency part is active. If the time length is larger than or equal to a second threshold, the terminal device 110 may determine a reference frequency part to be a scheduling frequency part. If the time length is smaller than the second threshold, the terminal device 110 may determine the reference frequency part to be an active frequency part before the last frequency part switching. This will be described with reference to FIG. 7.

FIG. 7 illustrates an example 700 of BWP switching or CC switching in accordance

with some embodiments of the present disclosure.

As shown, the terminal device 110 receives first RS 711-1, 711-2 and 711-3 from the network device 120 in the first BWP/CC. The first RS 711-1, 711-2 and 711-3 may be identified by (a first BWP/CC ID+RS ID). The terminal device 110 receives PDCCH 712 scheduling PDSCH 713 in the second BWP/CC.

The terminal device 110 receives the PDSCH 713 in the second BWP/CC by using the first RS 711-2 and 711-3 as QCL source RS. Dashed arrows in FIG. 7 represent no actual transmission or measurement. The network device 120 transmits second RS 721-1 in the second BWP/CC.

Before obtaining the second set of properties by measuring the second RS 721-1 in the second BWP/CC, the terminal device 110 switches from the second BWP/CC to a third BWP/CC. The terminal device 110 receives PDCCH 714 scheduling PDSCH 715 in the third BWP/CC.

Because the time length during which a scheduling BWP/CC (i.e., the second BWP/CC) is active is smaller than the second threshold, the terminal device 110 determines the reference BWP/CC to be the first BWP/CC before the last BWP/CC switch. Thus, the terminal device 110 receives PDSCH 715 in the third BWP/CC based on the first set of properties by using the first RS 711-2 and 711-3 as the QCL source RS. In the third BWP/CC, the terminal device 110 obtains a fourth set of properties by measuring the third RS 731-1 and 731-2. In turn, the terminal device 110 receives PDSCH 716 based on the fourth set of properties by using the third RS 731-1 and 731-2 as the QCL RS.

With the solution in the example 700, the problem of fast BWP/CC switching may be avoided.

As mentioned above, the TCI-State IE may indicate qcl-Type1 and qcl-Type 2. For example, the qcl-Type1 may be QCL Type A or B, C for DL, and the qcl-Type2 may be QCL Type D for DL or UL Tx spatial filter for UL.

In some embodiments, the terminal device 110 may obtain the first set of properties by measuring the first RS and a third RS, and obtain the second set of properties by measuring the second RS and a fourth RS. Both the third RS and the fourth RS have a second ID (also referred to as second RS ID). In some embodiments, the first RS and the second RS may be RS of QCL type A/B/C, and the third RS and the fourth RS may be RS of QCL type D. In such embodiments, if BWP/CC ID is absent for RSs of QCL type A/B/C and for RSs of QCL type D in both QCL-Info of a TCI-state, the terminal device 110 may handle QCL type A/B/C and QCL type D assumptions differently.

In some embodiments, by taking assumptions that QCL type A/B/C RS (i.e., the first RS and second RS) may be identified by the first RS ID, QCL type D RS (i.e., the third RS and fourth RS) may be identified by the second RS ID, and BWP/CC ID is absent for both QCL type A/B/C RS and QCL type D RS in both QCL-Info of a TCI state, the following scenarios need to be handled.

Scenario 1: the first RS ID and the second RS ID are different, and QCL type D relationship is always assumed between RS identified by the first BWP/CC ID+the second RS ID and RS identified by the second BWP/CC ID+the second RS ID, e.g., the third RS and the fourth RS.

Scenario 2: the first RS ID and the second RS ID are different, and QCL type D relationship is always NOT assumed between the third RS and the fourth RS.

Scenario 3: the first RS ID and the second RS ID are the same, and QCL type D relationship is always assumed between the third RS and the fourth RS.

Scenario 4: the first RS ID and the second RS ID are the same, and QCL type D relationship is always NOT assumed between the third RS and the fourth RS.

In some embodiments, different time durations depend on whether QCL type D RS and QCL type A/B/C RS are the same, whether QCL type D relationship is assumed between the third RS and the fourth RS.

In some embodiments, if QCL type D relationship is assumed between the third RS and the fourth RS, it means that both RSs may be received via the same receiving (Rx) beam.

In such embodiments, there is no need to refine Rx beam after BWP/CC switching.

In other embodiments, if QCL type D relationship is not assumed between the third RS and the fourth RS, it means that both RSs may or may not be received via the same Rx beam. In such embodiments, the terminal device 110 may determine a refinement time interval (represented by T_{BeamRefinement}) for refining the Rx beam after the BWP/CC switching. In turn, the terminal device 110 may update the QCL time interval T_{QCL} based on the refinement time interval and the QCL time interval T_{QCL}. For example, the terminal device 110 may extend T_{QCL} to max (T_{QCL}, T_{BeamRefinement}) or (T_{QCL}+T_{BeamRefinement}).

In embodiments where the QCL type D relationship is not assumed, if the first RS ID and the second RS ID are different, it means that the terminal device 110 could obtain

QCL Type A parameters by using another TCI configured for the QCL Type D RS. Thus, the terminal device 110 may need to refine Rx beam after BWP/CC switching. In addition, the terminal device 110 may update T_{QCL} with a longer one of T_{QCL} and T_{BeamRefinement}. In other words, the terminal device 110 may update T_{QCL} with max (T_{QCL}, T_{BeamRefinement}).

In embodiments where the QCL type D relationship is not assumed, if the first RS ID and the second RS ID are the same, it means the terminal device 110 needs to obtain QCL Type A and D parameters from the same RS. The terminal device 110 needs to first find Rx beam (QCL type D parameters), and then applies this Rx beam to further obtain QCL type A parameters. In addition, the terminal device 110 may update T_{QCL} with a sum of T_{QCL} and T_{BeamRefinement}.

In some embodiments, for UL, QCL-Type D source RS should be interpreted as target RSs may be transmitted via the same transmitting (Tx) beam as source RS or target RSs may be transmitted via the corresponding Tx beam as Rx beam for source RS.

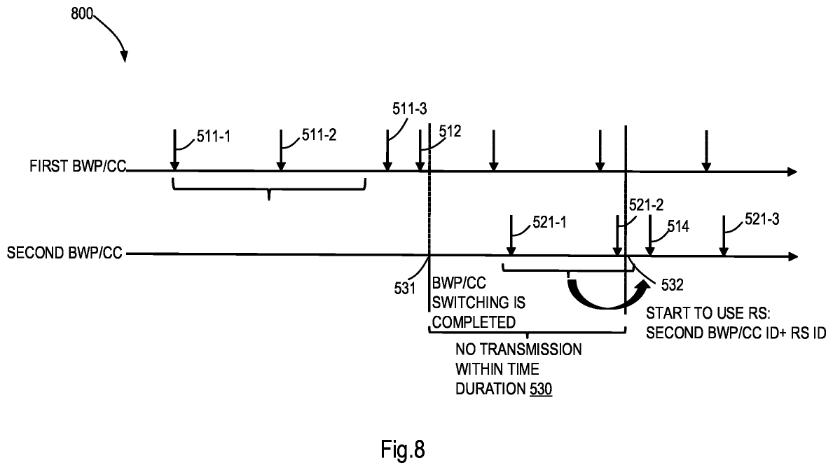

In some embodiments, during the time duration, the terminal device 110 may only receive the second RS without performing further communication with the network device 120. QCL reference RS may be always identified by the second BWP/CC ID+RS ID, which is aligned with Rel-17 agreement. This will be described with reference to FIG. 8.

FIG. 8 illustrates an example 800 of BWP switching or CC switching in accordance with some embodiments of the present disclosure.

As shown, the example 800 is similar to the example 500. The example 800 is different from the example 500 in that in the example 800, the terminal device 110 only receives the second RS 421-1 and 421-2 in the second frequency part without applying indicated TCI state to receive PDSCH 413 from the network device 120.

In embodiments where during the time duration, the terminal device 110 only receives the second RS without performing communication based on the indicated TCI state with the network device 120, the terminal device 110 may determine the time duration by performing the following.

The terminal device 110 may receive DCI from the network device 120. The DCI comprises a field of bandwidth part indicator (BWP ID) and a Transmission Configuration Indicator (TCI) field.

If the field of bandwidth part indicator indicates a new BWP, the terminal device 110 may determine a TCI application timing based on a slot when the DCI is acknowledged, a number of symbols after the last symbol of the acknowledgment, a configured time interval for the switching (T_{switch}) and the QCL time interval (T_{QCL}).

On the other hand, if the field of bandwidth part indicator indicates a current BWP, the terminal device 110 may determine the TCI application timing based on the slot when the DCI is acknowledged, and the number of symbols after the last symbol of the acknowledgment.

In some embodiments, if the field of bandwidth part indicator indicates a new BWP and the field of TCI indicates a new TCI state different from the current TCI state, the terminal device 110 may determine a TCI application timing based on a slot when the DCI is acknowledged, a number of symbols after the last symbol of the acknowledgment, a configured time interval for the switching (T_{switch}) and the QCL time interval (T_{QCL}), if the field of bandwidth part indicator indicates a new BWP and the field of TCI indicates an TCI state same as the current TCI state, the terminal device 110 may determine a TCI application timing based on a slot when the DCI is acknowledged, a number of symbols after the last symbol of the acknowledgment, a configured time interval for the switching (T_{switch}).

Upon determining the TCI application timing, the terminal device 110 may determine the time duration based on the TCI application timing. For example, the terminal device 110 may determine the TCI application timing as an end of the time duration.

Alternatively, in embodiments where during the time duration, the terminal device 110 only receives the second RS without performing communication based on the indicated TCI state with the network device 120, the time duration may be related to the value of bwp-Inactivity Timer or be related to the time length where scheduling BWP/CC is active.

After the determined TCI application timing, the terminal device receives PDSCH based on the indicated TCI state, if BWP/CC ID is absent for the QCL source RS in a QCL-Info of the TCI state, the terminal device assumes QCL source RS is in the BWP/CC to which the TCI state applies. In addition, after the determined TCI application timing, the terminal device receives/transmits all channels/RSs that the indicated TCI state apply to, which at least includes one of terminal device dedicated PDCCH/PDSCH, terminal device dedicated PUCCH/PUSCH, according to the QCL assumption that QCL source RS is in the BWP/CC to which the TCI state applies.

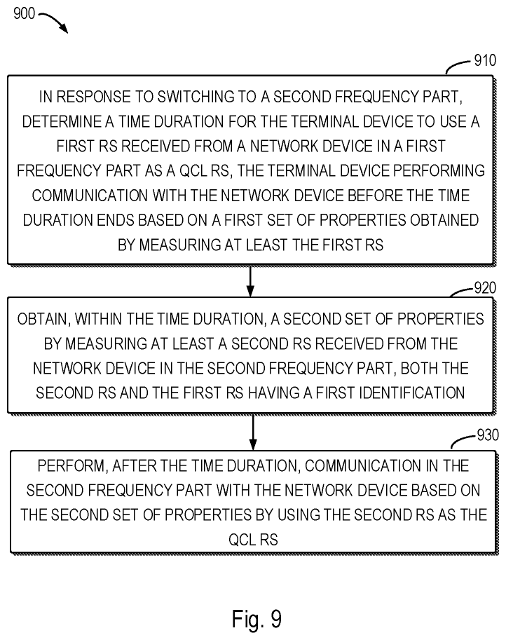

FIG. 9 illustrates a flowchart of an example method 900 in accordance with some embodiments of the present disclosure. In some embodiments, the method 900 can be implemented at a terminal device. For example, the method 900 can be implemented at the terminal device 110 as shown in FIG. 1.

At block 910, in response to switching to a second frequency part, the terminal device determines a time duration for the terminal device to use a first RS received from a network device in a first frequency part as a QCL RS. The terminal device performs communication with the network device before the time duration ends based on a first set of properties obtained by measuring at least the first RS.

At block 920, the terminal device obtains, within the time duration, a second set of properties by measuring at least a second RS received from the network device in the second frequency part. The second RS and the first RS have a first identification.

At block 930, the terminal device performs, after the time duration, communication in the second frequency part with the network device based on the second set of properties by using the second RS as the QCL RS.

In some embodiments, determining the time duration comprises: determining, based on configuration information received from the network device, a starting slot when the terminal device is aware of the switching and a configured time interval for the switching: determining a QCL time interval for obtaining the second set of properties: determining the time duration based on at least one of the starting slot, the configured time interval for the switching and the QCL time interval.

In some embodiments, determining the QCL time interval comprises: obtaining, from the configuration information, at least one parameter of the following: a periodicity of the second reference signal, a configured number of transmission occasions of the second reference signal, a QCL type of the second reference signal, numerology information the second reference signal, or a predefined capability-related value of the terminal device; and determining the QCL time interval based on the at least one parameter.

In some embodiments, the configured number is determined from at least one of: the configuration information, a capability of the terminal device, or a standard requirement.

In some embodiments, obtaining a second set of properties comprises: determining a QCL type of the second reference signal based on configuration information received from the network device: and determining the second set of properties based on the QCL type by measuring a second reference signal in the second frequency part.

In some embodiments, the switching from the first frequency part to the second frequency part is bandwidth part (BWP) switching or Component Carrier (CC) switching.

In some embodiments, the first frequency part is one of the following: an active BWP before the BWP switching, an active CC before the CC switching, a BWP or CC in which the scheduling information is transmitted, a BWP or CC in which TCI-State is configured, a BWP or CC in which one or more TCI state pools are configured, a reference BWP or a reference CC, a default BWP or a default CC, an initial downlink or uplink BWP, or an initial downlink or uplink CC.

In some embodiments, the method 900 further comprises: in response to switching back from the second frequency part to the first frequency part due to expiry of a timer, determining a time period of the timer from the last transmission in the first frequency part: in accordance with a determination that the time period is smaller than a first threshold, performing communication with the network device in the first frequency part by using the first reference signal as the QCL reference signal.

In some embodiments, the method 900 further comprises: in accordance with a determination that the time period is larger than or equal to the first threshold, performing communication with the network device in the first frequency part by using the second reference signal as the QCL reference signal: obtaining a third set of properties by measuring the first reference signal, and performing communication with the network device in the first frequency part based on the third set of properties by using the first reference signal as the QCL reference signal.

In some embodiments, the time period is related to a value of bwp-Inactivity Timer.

In some embodiments, the method 900 further comprises: in response to further switching from the second frequency part to a third frequency part before the second set of properties are obtained, determining a time length during which a scheduling frequency part is active: in accordance with a determination that the time length is larger than or equal to a second threshold, determining a reference frequency part to be a scheduling frequency part: and in accordance with a determination that the time length is smaller than the second threshold, determining the reference frequency part to be an active frequency part before the last frequency part switching.

In some embodiments, the first set of properties is obtained by measuring the first reference signal and a third reference signal, the second set of properties is obtained by measuring the second reference signal and a fourth reference signal, both the third reference signal and the fourth reference signal have a second identification. In such embodiments, determining the QCL time interval comprises: if the QCL type D relationship is not assumed between the third reference signal and the fourth reference signal, determining a refinement time interval for refining a receiving beam after the switching: and updating the QCL time interval based on the refinement time interval and the QCL time interval.

In some embodiments, updating the QCL time interval comprises: if the first identification of the first and second reference signals is different from the second identification of the third and fourth reference signals, updating the QCL time interval with a longer one of the refinement time interval and the QCL time interval.

In some embodiments, updating the QCL time interval comprises: if the first identification of the first and second reference signals is the same as the second identification of the third and fourth reference signals, updating the QCL time interval with a sum of the QCL time interval and the refinement time interval.

In some embodiments, during the time duration, the terminal device only receives the second reference signal, without performing further communication with the network device. In such embodiments, determining the time duration comprises: receiving downlink control information from the network device, the downlink control information comprising a field of bandwidth part indicator and a Transmission Configuration Indicator (TCI) field: in accordance with a determination that the field of bandwidth part indicator indicates a new bandwidth part, determining a TCI application timing based on a slot when the downlink control information is acknowledged, a number of symbols after the last symbol of the acknowledgment, a configured time interval for the switching and a QCL time interval: in accordance with a determination that the field of bandwidth part indicator indicates a current bandwidth part, determining the TCI application timing based on the slot when the downlink control information is acknowledged, and the number of symbols after the last symbol of the acknowledgment: and determining the time duration based on the TCI application timing.

In some embodiments, the method 900 further comprises: receiving configuration information from the network device, the configuration information comprising at least one of: a starting slot when the terminal device is aware of the switching, a configured time interval for the switching, a periodicity of the second reference signal, a configured number of transmission occasions of the second reference signal, a QCL type of the second reference signal, numerology information the second reference signal, or a predefined capability-related value of the terminal device.

In some embodiments, the method 900 further comprises: obtaining a TCI state indication from downlink control information or a MAC CE activation command received from the network device, In some embodiments, a TCI state identification (ID) in the TCI state indication points to a TCI state in a TCI state pool.

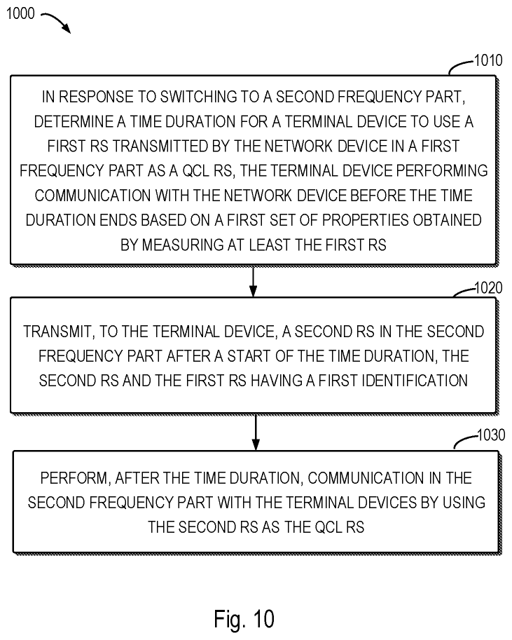

FIG. 10 illustrates a flowchart of an example method 1000 in accordance with some embodiments of the present disclosure. In some embodiments, the method 1000 can be implemented at a network device. For example, the method 1000 can be implemented at the network device 120 as shown in FIG. 1.

At block 1010, in response to switching to a second frequency part, the network device determines a time duration for a terminal device to use a first RS transmitted by the network device in a first frequency part as a QCL RS. The terminal device performs communication with the network device before the time duration ends based on a first set of properties obtained by measuring at least the first RS.

At block 1020, the network device transmits, to the terminal device, a second RS in the second frequency part after a start of the time duration, the second RS and the first RS having a first identification.

At block 1030, the network device performs, after the time duration, communication in the second frequency part with the terminal devices by using the second RS as the QCL RS.

In some embodiments, the method 1000 further comprises: transmitting configuration information to the terminal device. The configuration information comprises at least one of: a starting slot when the terminal device is aware of the switching, a configured time interval for the switching, a periodicity of the second reference signal, a configured number of transmission occasions of the second reference signal, a QCL type of the second reference signal, numerology information the second reference signal, or a predefined capability-related value of the terminal device.

In some embodiments, the method 1000 further comprises: transmitting, to the terminal device, downlink control information or a MAC CE activation command comprising a TCI state indication. In such embodiments, a TCI state identification (ID) in the TCI state indication points to a TCI state in a TCI state pool.

In some embodiments, the method 1000 further comprises: transmitting the second reference signal to the terminal device during the time duration, without performing further communication with the terminal device.

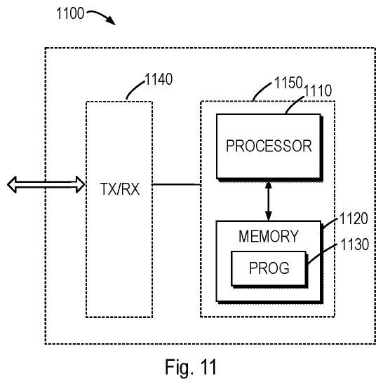

FIG. 11 is a simplified block diagram of a device 1100 that is suitable for implementing some embodiments of the present disclosure. The device 1100 can be considered as a further example embodiment of the terminal device 110 or the network device 120 as shown in FIG. 1. Accordingly, the device 1100 can be implemented at or as at least a part of the terminal device 110 or the network device 120.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1120 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1130 is assumed to include program instructions that, when executed by the associated processor 1110, enable the device 1100 to operate in accordance with the embodiments of the present disclosure, as discussed herein with reference to FIGS. 1 and 3 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 3 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-24. (canceled)

25. A method of a User Equipment (UE), the method comprising:
supporting a Bandwidth Part (BWP) switch which is configured to switch an active BWP from a first BWP where a first Transmission Configuration Indicator state (TCI-state) applies to a second BWP where a second TCI-state applies, wherein the first TCI-state associates a first Downlink (DL) reference signal, wherein the second TCI-state associates a second DL reference signal, and
wherein the UE is configured to perform communication with the first TCI-state before a delay in the second BWP in a case where the UE has information on the second TCI-state to perform the communication in the second BWP; and
assuming, in a case where the second DL reference signal is a Quasi Co-Location Type A or D source Reference Signal (QCL Type A/D source RS) and a bwp-id for the second DL reference signal in a QCL-info of the second TCI-state is not configured, that the second DL reference signal is configured in the second BWP where the second TCI-state applies.

26. The method according to claim 25,
wherein the UE is configured to perform the communication with the second TCI-state after the delay in the second BWP in a case where the UE has the information on the second TCI-state to perform the communication in the second BWP.

27. The method according to claim 25,
wherein the UE is configured to apply the first TCI-state from a reference BWP.

28. The method according to claim 25, further comprising:
assuming, in a case where the first DL reference signal is a QCL Type A/D source RS and a bwp-id for the first DL reference signal in a QCL-info of the first TCI-state is not configured, that the first DL reference signal is configured in the first BWP where the first TCI-state applies.

29. The method according to claim 28, further comprising:
receiving the first DL reference signal on the first BWP; and
receiving the second DL reference signal on the second BWP.

30. The method according to claim 25,
wherein the communication includes receiving a Physical Downlink Control Channel (PDCCH).

31. The method according to claim 25,
wherein the communication includes receiving a Physical Downlink Shared Channel (PDSCH).

32. A User Equipment (UE) comprising:
a memory; and
a processor coupled with the memory, wherein the processor is configured to:
support a Bandwidth Part (BWP) switch which is configured to switch an active BWP from a first BWP where a first Transmission Configuration Indicator state (TCI-state) applies to a second BWP where a second TCI-state applies, wherein the first TCI-state associates a first Downlink (DL) reference signal, wherein the second TCI-state associates a second DL reference signal, and
wherein the UE is configured to perform communication with the first TCI-state before a delay in the second BWP in a case where the UE has information on the second TCI-state to perform the communication in the second BWP, and
assume, in a case where the second DL reference signal is a Quasi Co-Location Type A or D source Reference Signal (QCL Type A/D source RS) and a bwp-id for the second DL reference signal in a QCL-info of the second TCI-state is not configured, that the second DL reference signal is configured in the second BWP where the second TCI-state applies.

33. The UE according to claim 32,
wherein the UE is configured to perform the communication with the second TCI-state after the delay in the second BWP in a case where the UE has the information on the second TCI-state to perform the communication in the second BWP.

34. The UE according to claim 32,
wherein the UE is configured to apply the first TCI-state from a reference BWP.

35. The UE according to claim 32,
wherein the processor is configured to:
assume, in a case where the first DL reference signal is a QCL Type A/D source RS and a bwp-id for the first DL reference signal in a QCL-info of the first TCI-state is not configured, that the first DL reference signal is configured in the first BWP where the first TCI-state applies.

36. The UE according to claim 35,
wherein the processor is configured to:
receive the first DL reference signal on the first BWP, and
receive the second DL reference signal on the second BWP.

37. The UE according to claim 32,
wherein the communication includes receiving a Physical Downlink Control Channel (PDCCH).

38. The UE according to claim 32,
wherein the communication includes receiving a Physical Downlink Shared Channel (PDSCH).
